(19) United States
(12) Patent Application Publication
(10) Pub. No.: US 2013/0167143 A1
(43) Pub. Date: Jun. 27, 2013

(54) SYSTEM FOR AUTOMATICALLY SETTING UP SMARTPHONES APPS

(71) Applicant: Seong-Noh YI, Goyang-si (KR)

(72) Inventor: Seong-Noh YI, Goyang-si (KR)

(73) Assignee: Korea Center.Com Co., Ltd., Seoul (KR)

(21) Appl. No.: 13/713,286

(22) Filed: Dec. 13, 2012

(30) Foreign Application Priority Data
Dec. 21, 2011 (KR) 10-2011-0139500

(51) Int. Cl. G06F 9/445

(52) U.S. Cl. CPC G06F 8/61
USPC 717/178

(57) ABSTRACT

A system for automatically setting up smartphone Apps, and the system previously stores initial execution information required to initially execute the smartphone App, downloads and installs the smartphone App, and initially execute the smartphone App based on the previously-stored initial execution information, thereby enabling a user to execute the smartphone App without a specific manipulation.

### CROSS-REFERENCE TO RELATED APPLICATION

This application claims the benefit under 35 U.S.C. §119(a) of Korean Patent Application No. 10-2011-0139500, filed on Dec. 21, 2011, the entire disclosure of which is incorporated herein by reference for all purposes.

### BACKGROUND

1. Field

The present invention relates to a technology for setting up smartphone Apps, and more specifically, to a system for automatically setting up smartphone Apps.

2. Description of the Related Art

Japanese Patent Laid-Open Publication No. 2007-286913 (Published on Nov. 1, 2007) relates to a technology for displaying address and authentication information of service data which can be provided via a PC with QR codes, imaging the QR code using a communication terminal device, acquiring the address and authentication information by recognizing the QR codes, and requesting service data by transmitting the address and authentication information to the PC.

The technology of related arts provides only locations about service data which can be provided using a QR code. In this technology, a smartphone App which is based on a user account requires a user to register user account information when the smartphone app is installed. Thus, the user has to login or authenticate the user's identification in order to execute the smartphone App, and needs to manually set commands that the smartphone App would carry out.

However, a smartphone's interface is inconvenient for the user to register user account information, set environment of the smartphone App or manually set commands carried out the smartphone App. This is why a technology for solving the inconvenience of registering user account information is needed. Under this background, the inventor of this present invention began to study a technology for automatically setting up smartphone Apps.

### RELATED ART DOCUMENT

### Patent Document

1. Japanese Patent Laid-Open Publication No. 2007-286913 (Published on Nov. 1, 2007)

### SUMMARY

The following description relates to a technology designed to address the above drawback, and aims to provide a system which previously stores initial execution information required to initially execute a smartphone App, downloads and installs the smartphone App, and initially executes the smartphone App based on the initial execution information, so that a user is able to execute the smartphone App without a specific manipulation.

In one general aspect of the present invention, a user Personal Computer (PC) sets initial execution information required to initially execute a predetermined smartphone App , stores the initial execution information in a first address, and generates an identification code including the first address, which indicates a location in which the initial execution information required to initially execute the predetermined smartphone app, and a second address, which denotes a location from which the predetermined smartphone app is downloaded.

In another general aspect of the present invention, a smartphone recognizes an identification code including a first address, which indicates a location in which initial execution information required to initially execute a smartphone App, and a second address, which denotes a location from which the smartphone App is downloaded; downloads the smartphone App at the second address included in the recognized identification code; installs the smartphone App; acquires the initial execution information at the first address included in the recognized identification code; and controls initial execution of the installed smartphone App based on the acquired initial execution information.

In another general aspect of the present invention, an App execution information management server, in response to a request for initial execution information required to initially execute a predetermined smartphone App from a smartphone, searches for the initial execution information at a first address and transmit the found initial execution information to the smartphone.

Other features and aspects will be apparent from the following detailed description, the drawings, and the claims.

### BRIEF DESCRIPTION OF THE DRAWINGS

FIG. 1 is a schematic diagram illustrating a system for automatically setting up smartphone Apps according to an exemplary embodiment of the present invention;

FIG. 2 is a block diagram illustrating a user Personal Computer (PC) in a system for automatically setting up smartphone Apps according to an exemplary embodiment of the present invention;

FIG. 3 is a block diagram illustrating a smartphone in a system for automatically setting up smartphone Apps according to an exemplary embodiment of the present invention;

FIG. 4 is a block diagram illustrating an App execution information management server in a system for automatically setting up smartphone Apps according to an exemplary embodiment of the present invention; and

FIG. 5 is a flow chart illustrating a method for automatically setting up a smart-phone App in a system for automatically setting up smartphone Apps according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

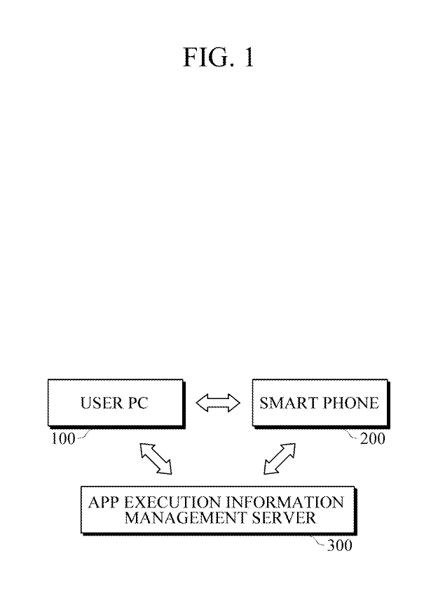

FIG. 1 is a schematic diagram illustrating a system for automatically setting up smartphone Apps according to an exemplary embodiment of the present invention. The system for automatically setting up smartphone Apps includes a user Personal Computer (PC) 100, a smartphone 200 and an App execution information management server 300.

The user PC 100 sets initial execution information required to initially execute a predetermined smartphone App, stores the initial execution information at a first address, generates an identification code including a first address and a second address, and outputs the identification code. At this time, the first address indicates a location in which initial execution information required to initially execute a predetermined smartphone App is stored, and the second address denotes a location from which the predetermined smartphone App is downloaded.

The smartphone 200 recognizes the identification code including the first address and the second address, downloads the corresponding smartphone App at the second address included in the recognized identification code, installs the downloaded smartphone App, acquires the initial information at the first address included in the recognized identification code, and controls initial execution of the installed smartphone App based on the acquired initial execution information.

In response to receiving a request for the initial execution information from the smartphone 200, the App execution information management server 300 searches for the initial execution information at the first address and transmits the found initial execution information to the smartphone 200.

In this manner, the system for automatically setting up smartphone Apps according to an exemplary embodiment of the present invention is able to previously store initial execution information required to initially execute a smartphone App, download and install the smartphone App, and execute the smartphone App based on the previously-stored initially execution information, so that a user may execute the smartphone App without a specific manipulation, thereby improving user convenience.

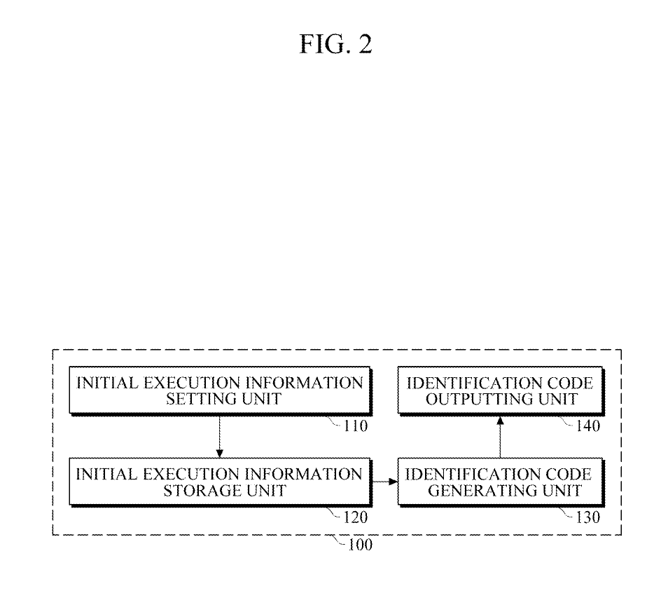

FIG. 2 is a block diagram illustrating a user PC in a system for automatically setting up smartphone Apps according to an exemplary embodiment of the present invention. Referring to FIG. 2, the user PC 100 includes an initial execution information setting unit 110, an initial execution information storage unit 120, an identification code generating unit 130 and an identification code outputting unit 140.

The initial execution information setting unit 110 sets initial execution information required to initially execute a predetermined smartphone App. At this time, the initial execution information setting unit 110 may provide a user interface and receive the initial information set by a user through the user interface.

For example, the initial execution information required to initially execute a predetermined smartphone App may be information about user account registration, such as account identification and password, information about environment settings of the predetermined smartphone App, such as an App execution time and an App execution event, or information about commands carried out by the predetermined smartphone App.

The initial execution information storage unit 120 stores the initial execution information at the first address. At this time, the initial execution information storage unit 120 may stores the initial execution information in the App execution information management server 300.

The identification code generating unit 130 generates an identification code, and the identification code includes a first address, which indicates a location in which the initial execution information required to initially execute a corresponding smartphone App is stored, and a second address, which denotes a location from which the corresponding smartphone App is downloaded. At this time, the identification code generating unit 130 may generate the identification code in the form of a bar code or a QR code.

Meanwhile, the second address may be acquired when a user requests the purchase of the corresponding predetermined smartphone App using a smartphone. In addition, the first address which is matched with the second address and indicates a location in which the initial execution information required to initially execute the smartphone App is stored may be set previously.

Meanwhile, the identification code generated by the identification code generating unit 130 may be encrypted using a public key-based encryption algorithm, and may further include a time stamp value indicating an issuance time or valid time of the identification code.

The identification code outputting unit 140 outputs the identification code generated by the identification code generating unit 130. For example, the identification code outputting unit 140 may display the identification code on a screen of the user PC 100, print the identification code using a printer device connected to the user PC 100 or transmit the identification code to the smartphone 200 wired/wirelessly connected to the user PC 100.

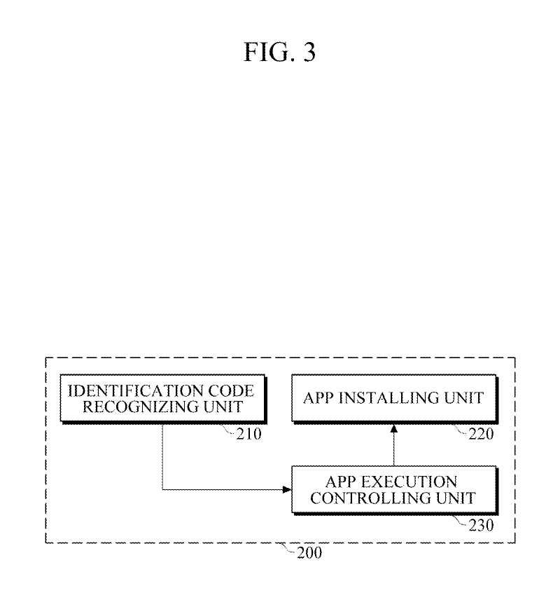

FIG. 3 is a block diagram illustrating a smartphone in a system for automatically setting up smartphone Apps according to an exemplary embodiment of the present invention. Referring to FIG. 3, the smartphone 200 includes an identification code recognizing unit 210, an App installing unit 200 and an App execution controlling unit 230.

The identification code recognizing unit 210 recognizes an identification code including a first address and a second address. The first address indicates a location in which initial execution information required to initially execute a predetermined smartphone App is stored, and the second address denotes a location from which the predetermined smartphone App is downloaded. At this time, the first address may be one of sub-addresses of an App execution information management server 300, and the second address may be one of sub-addresses of an App store.

When a user PC 100 generates an identification code including the first address and the second address and outputs the identification code, a user may photograph the identification code using a camera of the smartphone 200 and the identification code recognizing unit 210 may recognize the identification code based on the identification-code image photographed by the camera.

Meanwhile, in the case where the identification code is encrypted using a public key-based encryption algorithm, the identification code recognizing unit 210 may decrypt and then recognize the identification code. In the case where the identification code includes a time stamp value indicating an issuance time or valid time of the identification code, the identification code recognizing unit 210 may verify the validity of the identification code using the time stamp value.

The App installing unit 220 downloads a smartphone App at second address included in the identification code which is recognized by the identification code recognizing unit 210, and installs the smartphone App. Specifically, once the identification code recognizing unit 210 recognizes the identification code, the second address indicating a location from which the smartphone App is downloaded is acquired, and then the App installing unit 220 downloads the smartphone App at the acquired second address and installs the smartphone App. For example, the App installing unit 220 may download a smartphone App from an App store and install the smartphone App.

The App execution controlling unit 230 acquires initial execution information required to initially execute the corresponding smartphone App at a first address included in the identification code which is recognized by the identification code recognizing unit 210, and then controls initial execution of the installed smartphone App based on the acquired initial execution information. For example, the App execution controlling unit 230 may acquire the initial execution information from the App execution information management server 300.

Once the smartphone App is installed after being downloaded at the second address by the App installing unit 220, the App execution controlling unit 230 requests the initial execution information at the first address included in the identification code, which is recognized by the identification code recognizing unit 210, and acquires the initial execution information.

Once the initial execution information is acquired at the first address, the App execution controlling unit 230 controls the initial execution of the smartphone App based on the acquired initial execution information.

For example, the initial execution information required to initially execute a predetermined smartphone App may be information about user account registration, such as account identification and password, information about environment settings, such as App execution time or App execution event, or information about commands carried out by the predetermined smartphone App.

Meanwhile, the App execution controlling unit 230 may control the initial execution of the corresponding smartphone App by registering a user account based on the initial execution information, by setting the environment of the predetermined smartphone App based on the initial execution information or by setting commands carried out by the predetermined smartphone App based on the initial execution information.

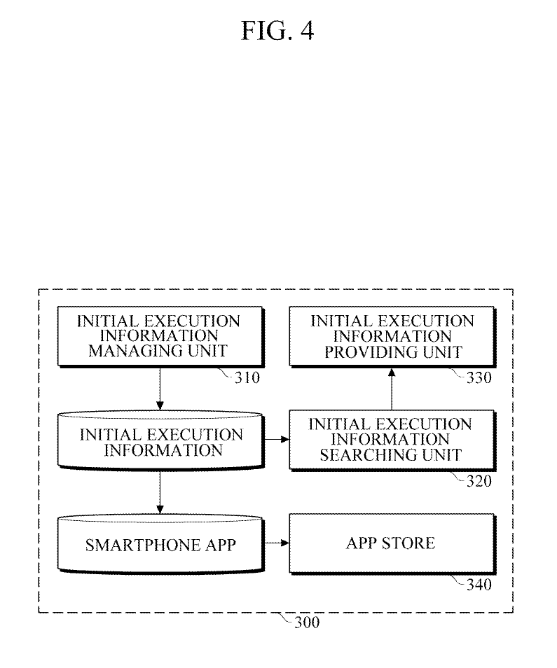

FIG. 4 is a block diagram illustrating an example of an App execution information management server in a system for automatically setting up smartphone Apps according to an exemplary embodiment of the present invention. Referring to FIG. 4, the App execution information management server 300 includes an initial execution information managing unit 310, an initial execution information searching unit 320 and an initial execution information providing unit 330.

The initial execution information managing unit 310 receives from a user PC 100 initial execution information required to initially execute a predetermined smartphone App, and stores the initial execution information at a first address. At this time the first address may be one of sub-addresses of the App execution information management server 300.

Once the initial execution information is set by a user, the user PC 100 transmits the initial execution information to the App execution information management server 300 and then the initial execution information managing unit 310 stores the initial execution information at the first address.

In response to a request for the initial execution information required to initially execute the predetermined smartphone App from the smartphone 200, the initial execution information searching unit 320 searches for the initial execution information stored at the first address.

Specifically, the corresponding smartphone App is downloaded at the second address, which indicates a location from which the smartphone App is downloaded, and then installed in the smartphone 200. Next, the smartphone 200 requests that the App execution information management server 300 transmit the initial execution information. Next, the initial execution information searching unit 320 searches the initial execution information stored at the first address.

The initial execution information providing unit 330 transmits the found initial execution information to the smartphone 200. In response to acquiring the initial execution information from the App execution information management server 300, the smartphone 200 control the initial execution of the installed smartphone App based on the acquired initial execution information.

For example, the initial execution information required to initially execute a predetermined smartphone App may be information about user account registration, such as account identification and password, information about environment settings of the smartphone App, such as App execution time and App execution event, or information about commands carried out by the smartphone App.

Meanwhile, the initial execution information provided by the initial execution information providing unit 330 may be information about user account registration, information about environment settings of the smartphone App, or information about commands carried out by the smartphone App.

Meanwhile, according to another exemplary embodiment of the present invention, the

App execution information management server 300 may further include an App store 340. In response to a request for downloading a predetermined smartphone App from the smartphone 200, the App store 340 searches the predetermined smartphone App at a second address and transmits the found smartphone App to the smartphone 200.

The above illustrates an exemplary case where the App execution information management server 300 includes the App store 340. In this case, in response to receiving a request for downloading a predetermined smartphone App from the smartphone 200, the App store 340 searches for the corresponding smartphone App at the second address, and transmits the found smartphone App to the smartphone 200 so as to install the smartphone App.

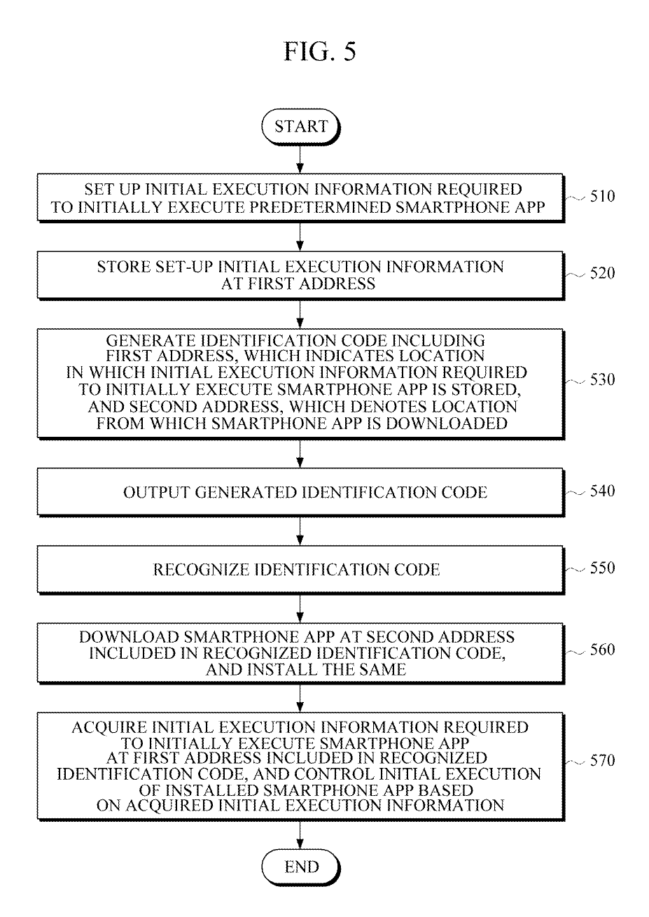

A method for automatically setting up smartphone Apps in a system for automatically setting up smartphone Apps described in the above will be provided with reference to FIG. 5. FIG. 5 is a flow chart illustrating an example of a method for automatically setting up smartphone Apps in a system for automatically setting up smartphone Apps according to an exemplary embodiment of the present invention.

In operation 510, initial execution information required to initially execute a predetermined smartphone App is set by a user in a user PC. Detailed descriptions about the initial execution information are provided in the above, so they will not be explained herein.

Next, in operation 520, the user PC stores the initial execution information at a first address. For example, the first address may be one of sub-addresses of an App execution information management server. In response to receiving the initial execution information from the user PC, the App execution information management server stores the initial execution information at the first address.

Next, in operation 530, the user PC generates an identification code including a first address and a second address. The first address indicates a location in which the initial execution information is stored, and the second address denotes a location from which the corresponding smartphone App is downloaded. At this time, it is able to generate the identification code in the form of a bar code or a QR code.

Next, in operation 540, the user PC outputs the generated identification code. At this time, the identification code may be displayed on a screen of the user PC, printed using a printer device connected to the user PC, or transmitted to a smartphone wired/wirelessly connected to the user PC.

Next, in operation 550, the smartphone recognizes the identification code including the first address and the second address. Detailed descriptions about recognizing the identification code are provided in the above, so they will not be explained herein.

Next, in operation 560, the smartphone downloads the smartphone App at a second address included in the recognized identification code and installs the smartphone App. At this time, the second address may be one of sub-addresses of an App store.

For example, if the App execution information management server includes the App store, the App execution information management server searches the App store for a smartphone App which is requested from the smartphone to be downloaded, and transmits the found smartphone App to the smartphone so as to install the smartphone App.

In response to installing the smartphone App, the smartphone, in operation 570, acquires the initial execution information required to initially execute the smartphone App at the first address included in the identification code that is recognized in operation 550, and controls initial execution of the installed smartphone App based on the acquired initial execution information.

At this time, in response to a request for the initial execution information required to initially execute the smartphone App from the smartphone, the App execution information management server searches for the initial execution information at the first address and transmits the initial execution information to the smartphone.

Next, in response to acquiring the initial execution information, the App execution information management server controls the initial execution of the installed smartphone App based on the acquired initial execution information.

According to the above exemplary embodiments of the present invention, the present invention previously stores initial execution information required to initially execute a smartphone App, downloads and installs the smartphone App, and initially executes the smartphone App based on the previously-stored initial execution information, so that a user may execute the smartphone App without a specific manipulation, and thus, the above-mentioned object of the present invention may be achieved.

The present invention previously stores initial execution information required to initially execute a smartphone App, downloads and installs the smartphone App, and initially executes the smart-phone App based on the initial execution information, so that a user is able to execute the smart-phone App without a specific manipulation, thereby improving user convenience

The present invention may be used in a technology for setting up a smartphone App and relevant application technologies.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for automatically setting up smartphone Apps, the system comprising:
a user Personal Computer (PC),
wherein the user PC comprises
an initial execution information setting unit configured to set up initial execution information required to initially execute a predetermined smartphone App;
an initial execution information storage unit configured to store the set-up initial execution information;
an identification code generating unit configured to generate an identification code comprising a first address, which indicates a location in which the initial execution information is stored, and a second address, which denotes a location from which the predetermined Smartphone App is downloaded; and
an outputting unit configured to output the generated identification code.

2. The system of claim 1, wherein the identification code is a bar code or a QR code.

3. The system of claim 1, wherein the initial execution information storage unit stores the initial execution information in an App execution information management server.

4. A system for automatically setting up smartphone Apps, comprising:
a smartphone,
wherein the smartphone comprises
an identification code recognizing unit configured to recognize an identification code comprising a first address, which indicates a location in which initial execution information required to initially execute a smartphone App, and a second address, which denotes a location from which the smartphone App is downloaded;
an App installing unit configured to download the smartphone App at the second address included in the recognized identification code and install the smartphone App; and
an App execution controlling unit configured to acquire the initial execution information at the first address included in the recognized identification code, and control initial execution of the installed smartphone App based on the acquired initial execution information.

5. The system of claim 4, wherein the App execution controlling unit controls the initial execution of the smartphone App by registering a user account based on the initial execution information.

6. The system of claim 4, wherein the App execution controlling unit controls the initial execution of the smartphone App by setting an environment of the smartphone App based on the initial execution information.

7. The system of claim 4, wherein the App execution controlling unit controls the initial execution of the smartphone App by setting commands carried out by the smartphone App based on the initial execution information.

8. The system of claim 4, wherein the first address is one of sub-addresses of the App execution information management server.

9. The system of claim 4, wherein the second address is one of sub-addresses of an App store.

10. A system for automatically setting up smartphone Apps, comprising
an App execution information management server,
wherein the App execution information management server comprises
an initial execution information managing unit configured to receive initial execution information required to initially execute a predetermined smartphone App from a user PC, and store the initial execution information at a first address;
an initial execution information searching unit configured to, in response to a request for the initial execution information from a smartphone, search for the smartphone App stored at the first address; and
an initial execution information providing unit configured to transmit the found initial execution information to the smartphone.

11. The system of claim 10, wherein the App execution information management server further comprises
an App store configured to, in response to a request for downloading the predetermined smartphone App from the smartphone, search for the smartphone App at a second address and transmit the found smartphone App to the smartphone.

12. The system of claim 10, wherein the initial execution information transmitted from the initial execution information providing unit is information about user account registration.

13. The system of claim 10, wherein the initial execution information transmitted from the initial execution information providing unit is information about environment settings of the smartphone App.

14. The system of claim 10, wherein the initial execution information transmitted from the initial execution information providing unit is information about commands carried out by the smartphone App.
